(19) United States
(12) Patent Application Publication
(10) Pub. No.: US 2013/0341874 A1
(43) Pub. Date: Dec. 26, 2013

(54) Gasket Material, Gaskets, and Related Methods

(71) Applicant: GARLOCK SEALING TECHNOLOGIES LLC, Palmyra, NY (US)

(72) Inventors: Aydin Aykanat, Palmyra, NY (US); Joseph D. Young, Palmyra, NY (US); Stefan Pitolaj, Palmyra, NY (US); Earl J. Rogalski, Palmyra, NY (US)

(73) Assignee: GARLOCK SEALING TECHNOLOGIES LLC, Palmyra, NY (US)

(21) Appl. No.: 13/655,732

(22) Filed: Oct. 19, 2012

Related U.S. Application Data
(60) Provisional application No. 61/664,549, filed on Jun. 26, 2012.

(51) Int. Cl. F16L 19/00; B29C 59/02

(52) U.S. Cl. 277/612; 264/320

(57) ABSTRACT

A method of manufacturing a gasket material may comprise inserting a polymer sheet into a press, and pressing the polymer sheet with a mold comprising opposing arrays of protrusions to define interconnected sealing ridges surrounding an array of indentations on each major surface of the polymer sheet. A gasket material may comprise a polymer sheet comprising a first major surface and a second major surface, the second major surface opposing the first major surface. Interconnected sealing ridges may define an array of indentations on the first major surface of the polymer sheet. Additionally, interconnected sealing ridges may define an array of indentations on the second major surface of the polymer sheet, substantially symmetric to the first major surface.

### BACKGROUND

A gasket, in certain aspects, is a material or combination of materials clamped between two separable members or flanges of a mechanical joint The gasket functions to effect a seal between the flanges and maintain the seal for an extended period of time. The flanges may be secured together with bolts to form a joint. Common forces that may affect the joint include bolt load, hydrostatic end force, and blowout pressure. A gasket, in many applications, must be capable of sealing the mating surfaces, and be impervious and resistant to the sealed media, which may be referred to as chemically inert. The gaskets also must be able to withstand the application of elevated temperature and pressure in many applications.

Piping in corrosive applications, such as encountered in chemical plants, frequently use plastic like polyvinyl chloride (PVC), fiber reinforced plastic (FRP), and glass lined piping. It will be appreciated that piping systems using these materials are somewhat fragile and require a gasket that will effect a seal at relatively low bolt loads because high bolt loads may crack or otherwise damage the flanges. The gasket also must be dimensionally stable so as to maintain a seal during a range of possible thermal changes in the process (i.e., generally known as creep resistance) and have broad chemical compatibility (i.e., generally known as chemically inert).

Prior attempts to address the problems associated with gaskets for use in fragile joints have included, for example, envelope gaskets, rubber gaskets, rubber/polytetraflouroethylene (PTFE) gaskets, filled PTFE sheet gaskets, reduced area gaskets (ie. sections of gaskets are cut and removed away), porous PTFE sheet gaskets (such as expanded PTFE), microcellular PTFE gaskets and composite PTFE sheet gaskets to name but a few. PTFE is commonly employed for gasketing in severe or corrosive chemical environments as it has a number of desirable properties for use as a gasketing material. For example, PTFE is inherently tough, chemically inert, has good tensile strength, and is stable over a broad range of temperatures. However, pure PTFE polymer is not highly compressible (which also means PTFE gaskets typically require higher bolt loads), and also is prone to creep, both of which may result in the formation of leak paths.

Envelope gaskets are a composite structure where a PTFE envelope is filled with a more compressible filler, such as compressed fiber or felt. The PTFE envelope provides chemical resistance while deformability is provided by the filler material. However, PTFE envelopes are relatively thin (0.010 to 0.020 inch) and can develop pin holes during manufacture or while in service, thereby exposing the filler to incompatible corrosive media, which, may result in the formation of a leak path as the filler is frequently not as resistant to the corrosive environment The envelope gaskets also, have the least compressible component i.e., the PTFE envelope as the outermost gasket surface.

Rubber gaskets are used routinely in plastic and FRP flanges because of their compressibility and resiliency, and their ability to seal at relatively low bolt loads. However, rubber gaskets have limited chemical and temperature resistance, and the proper compound must be specified for each application. Thus, multiple process streams that use the same piping are likely to require a time-consuming and somewhat costly change of gaskets. Some envelope gaskets use a rubber/PTFE combination that bonds a PTFE envelope at the inner dimension of a rubber gasket. The envelope enhances the chemical resistance while the rubber substrate provides compressibility and deformability. Again however, the PTFE envelopes are thin (0.010 to 0.020 inch) and can develop pin holes during manufacture or while in service, thereby exposing the rubber substrate to incompatible corrosive media. Likewise, the PTFE envelope, which is not highly compressible, is the outermost layer in a rubber/PTFE envelope gasket.

Filled PTFE sheets with good compressibility can be achieved by incorporating microballoons into the PTFE sheet material. Although PTFE sheet material offers the flexibility to be trimmed and modified by an end user, filled PTFE sheet material typically requires relatively high bolt loads to seal. Microcellular PTFE sheets can be produced using a number of techniques, one of which involves adding a filler to the PTFE prior to forming the sheet and then removing the filler after the sheet is formed. Thus, voids remain in the PTFE sheet material which give it a desired porosity (i.e., microcellular PTFE). Another method involves a particular sequence of extruding, stretching, and then heating to form a product known as expanded PTFE. However, microcellular and porous PTFE are generally very soft and flexible and can be difficult to install in situations where limited flange separation is possible. Further, because microcellular and expanded PTFE sheets are porous, a gasket cut from either must be fully compressed to close off the voids to prevent leakage through the gasket, and gaskets cut from these sheets typically require relatively high bolt loads to seal, in order to address the rigidity issues associated with microcellular PTFE material, it has been proposed to laminate layers of microcellular PTFE and/or expanded PTFE sheets to full density PTFE substrate, but testing has shown that these materials likewise require relatively high bolt loads to seal.

In view of the foregoing, improved gasket material, gaskets and related methods would be desirable.

### SUMMARY

In one aspect of the disclosure, a method of manufacturing a gasket material may comprise inserting a polymer sheet into a press.

In a further aspect of the technology, a sheet or prefabrication of the gasket material may be formed by a sintering process and cold coining the sheet or prefabrication of the gasket material into the final form. The sintering process may be used to form filled or unfilled restructured or skived PTFE for cold coining. The cold coining process may plastically deform the sheet material into, the desired, form.

In a further aspect, which may be combined with any other aspect, the method may further comprise heating the polymer sheet prior to pressing the polymer sheet.

In a further aspect, which may be combined with any other aspect, heating the polymer sheet prior to pressing the polymer sheet may comprise heating the polymer sheet to a gel point.

In a further aspect, which may be combined with any other aspect, heating the polymer sheet prior to pressing the polymer sheet may comprise heating the polymer sheet to a temperature of about 371° C.

In a further aspect, which may be combined with any other aspect, the method may further comprise heating the polymer sheet within the mold.

In a further aspect, which may be combined with any other aspect, the method may further comprise heating the polymer sheet for about 15 minutes.

In a further aspect, which may be combined with any other aspect, the method may further comprise cooling the polymer sheet within the mold.

In a further aspect, which may be combined with any other aspect, cooling the polymer sheet within the mold may comprise cooling the polymer sheet within the mold for about 10 minute.

In a further aspect, which may be combined with any other aspect, pressing the polymer sheet with the mold may further comprise forming indented regions that are more dense than the interconnected sealing ridges in the polymer sheet with the mold.

In a further aspect, which may be combined with any other aspect, inserting the polymer sheet into the press may further comprise inserting a sintered and/or unsintered, restructured and/or skived PTFE sheet into the press.

In a further aspect, which may be combined with any other aspect, inserting the PTFE into the press may further comprise inserting a sintered and/or unsintered restructured and/or skived PTFE sheet filled with at least one of microballoons, barium sulfate, and crystalline silica and other polymeric/organic (PPS, Ekonol, PPSO2, PEEK, etc) and/or inorganic fillers (silicone carbide, glass fiber, alumina, etc) into the press.

In a further aspect, which may be combined with any other aspect, the method may further comprise drying the PTFE sheet to substantially remove any solvent within PTFE sheet prior to inserting the PTFE sheet into the press.

In a further aspect, which may be combined with any other aspect, drying the PTFE sheet may comprise heating the PTFE sheet to a temperature of about 107°°C.

In a further aspect, which may be combined with any other aspect, the method may further comprise applying an average pressure of between about 13.8 mpa and about 20.7 mpa to the polymer sheet with the press.

In another aspect of the disclosure, a gasket material may comprise a polymer sheet comprising a first major surface and a second major surface, the second major surface opposing the first major surface.

In a further aspect, which may be combined with any other aspect, interconnected sealing ridges may define an array of indentations on the first major surface of the polymer sheet.

In a further aspect, which may be combined with any other aspect, interconnected sealing ridges may define an array of indentations on the second major surface of the polymer sheet, substantially symmetric to the first major surface.

In a further aspect, which may be combined with any other aspect, the polymer sheet may comprise a sintered and/or unsintered, restructured and/or skived PTFE sheet.

In a further aspect, which may be combined with any other aspect, the PTFE sheet may comprise PTFE filled with at least one of microballoons, barium sulfate, and crystalline silica and other polymeric/organic (PPS, Ekonol, PPSO2, PEEK, etc) and/or inorganic fillers (silicone carbide, glass fiber, alumina, etc).

In a further aspect, which may be combined with any other aspect, indented regions of the polymer sheet may be more dense than the interconnected sealing ridges of the polymer sheet.

In a further aspect, which may be combined with any other aspect, the interconnected sealing ridges in the first major surface may define an array of rectangular or square or circular or honeycomb indentations on the first major surface of the polymer sheet and the interconnected sealing ridges in the second major surface may define an array of rectangular or square or circular or honeycomb indentations on the second major surface of the polymer sheet.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an isometric view of a gasket material sheet that includes interconnected sealing ridges forming a honeycomb pattern, according to an embodiment of the present disclosure.

FIG. 2 is an isometric view of a gasket cut from a gasket material sheet, such as shown in FIG. 1.

FIG. 3 is a side view of a flange joint including a gasket, such as shown in FIG. 2.

FIG. 4A is a cross-sectional detail view of a portion of the flange joint shown in FIG. 3 wherein the flange joint is in an open position and the gasket is in an uncompressed state.

FIG. 4B shows the cross-sectional view of the flange joint shown in FIG. 4A in a fully closed position with the gasket in a compressed state.

FIG. 5 is an isometric view of a mold assembly for preparing a gasket material sheet, such as shown in FIG. 1.

FIG. 6 is an isometric detail view of the mold shown in FIG. 5.

FIG. 7 is an isometric view of a platen press for use with a mold, such as shown in FIG. 5.

FIG. 8 is an isometric view of a roller press for use in manufacturing a gasket material sheet such as shown in FIG. 1.

FIG. 9 is an isometric detail view of a mold plate for preparing a gasket material sheet that includes rectangular protrusions, according to an embodiment of the present disclosure.

FIG. 10 is an isometric detail view of a gasket material sheet including interconnected ridges defining rectangular indentations such as prepared by the mold shown in FIG. 9, according to an embodiment of the present disclosure.

FIG. 11 is an isometric detail view of a mold for preparing a gasket material sheet that includes circular shaped protrusions, according to an embodiment of the present disclosure.

FIG. 12 is an isometric detail view of a gasket material sheet prepared by a mold, such as shown in FIG. 11, according to an embodiment of the present disclosure.

FIG. 13 is a plane, elevation, and perspective view of a mold for a rectangular pattern where the mold forms equilateral triangular ridges.

FIG. 14 is an isometric view of a rectangular mold where the protrusions are beveled.

FIG. 15 is an isometric view of a hexagonal pattern mold where the protrusions are beveled.

FIG. 16 is an isometric view of a circular or elliptical pattern where the protrusions are beveled.

FIG. 17 is an isometric view of a circular or elliptical pattern where the protrusions are not beveled.

FIG. 18 is an isometric view of a rectangular gasket sheet.

FIG. 19 is an isometric view of a honeycomb mold with beveled or tapered protrusions.

FIG. 20 is a top view of a honeycomb gasket sheet material.

FIG. 21 is a view of a honeycomb gasket for a flanged connection without an alignment tab.

FIG. 22 is a view of a honeycomb gasket for a flanged connection including a metal insert for rigidity.

FIG. 23 is a view of the gasket of FIG. 22 showing the metal insert core.

FIG. 24 is a honeycomb ring gasket.

FIGS. 25 and 26 are honeycomb gaskets for a flange.

FIG. 27A-B are molds for a rectangular gasket sheet.

FIG. 28 is shows a plurality of gasket sheets and a gasket cut from a gasket sheet made from the mold of FIGS. 27A-B.

FIG. 29 shows a rectangular gasket sheet.

FIGS. 3OA and 3OB show gaskets having rectangular indentations installed on a flange of a flanged connection.

FIGS. 31A-B show a test rig to pressure test the gaskets of FIG. 30 and 31.

FIG. 32 shows the gasket installed between flanges in the test rig of FIG. 32.

FIG. 33 is a view of a cold coining mold.

FIG. 34 is an isometric view of a cold coining mold.

FIGS. 35 and 36 show views of a gasket sheet having a dimpled pattern formed by the cold coining mold.

FIGS. 37 and 38 shows views of a ring gasket cut from the gasket sheet of FIGS. 35 and 36.

FIG. 39 is a cross-sectional view of a composite gasket consistent with the technology of the present application.

While the embodiments described herein are susceptible to various Modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives felling within the scope of the appended claims. Throughout the drawings, identical reference numbers designate similar, but not necessarily identical elements.

### DETAILED DESCRIPTION

Some embodiments of the present disclosure relate to gaskets for gasketed joints in pressurized fluid systems; for example, gaskets for use in joints between pipes in a fluid pipeline. Many fluid systems, such as industrial plants, use plastic (e.g., PVC or FRP piping) or glass lined piping in order to handle chemicals that are highly corrosive or otherwise might react with other pipes, such as metal pipes. One difficulty in utilizing PVC or FRP piping, or similar fragile piping, is that low bolt loads at the joints, such as flange joints, are required to keep from cracking, breaking, or otherwise damaging the flanges at the joint. Addressing these difficulties, gaskets, according to embodiments of the present disclosure, may provide an effective seal at a flange joint under a relatively low bolt load; for example, at bolt loads of 5 ft-lbs, or less in certain applications.

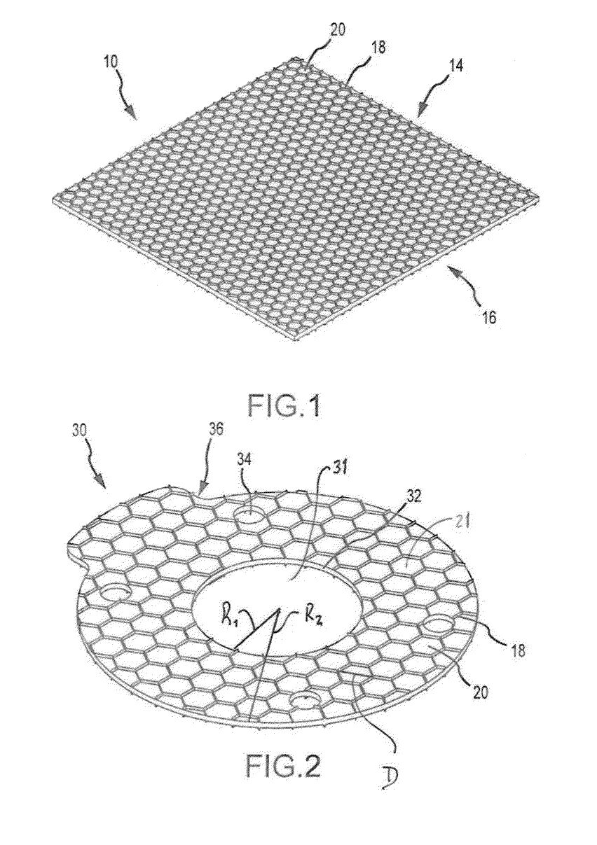

In some embodiments, as shown in FIG. 1, a gasket material 10 may comprise a sheet comprised of a polymer, such as a full density polytefrafluoroethylene (PTFE). Full density PTFE is sometimes referred to as restructured PTFE. Full density PTFE (or restructured PTFE) is distinguishable from expanded PTFE (or e-PTFE) as full density PTFE is non-porous, such a full density PTFE is currently available as GYLON® sheet material from Oarlock Sealing Technologies located at 1666 Division Street, Palmyra, N.Y. 14522 USA. Commercially available GYLON® gasket materials include Style 3500, 3510, 3504 and other full density, filled/unfilled gasket sheets.

Full density PTFE sheets also may be formed by compressing a granular filled, or unfilled, PTFE powder to product, a sheet of preformed PTFE material, typically the perform is a press molding process at ambient temperatures, the press generally operates at about 3,000 to 5,000 psi (pounds per square inch). The preform is next sintered in a baking oven. The baking over first raises the temperature of the preform from ambient temperatures to approximately 350° C. to 390° C. for a period of time, typically sufficient such that the voids in the preform are filled, and second lowers the temperature back to ambient temperatures. The full density PTFE is then skived from the carrier.

Unexpectedly, it has been discovered that certain aspects of the technology disclosed herein provide a microcellular (or porous) materials that may be used in low bolt load applications when such microcellular materials are combined, in a layered composite, for example, with a core sheet of full density material as shown in FIG. 39. In other words, a pair of porous PTFE layers 1, 2, such as microcellular and expanded-PTFE may be provided on opposing sides of a non-porous, full density PTFE layer 3. The porous PTFE is more compressible than full density PTFE and provides a seal that operates with low bolt loads while the full density PTFE provides a relatively fluid impervious layer so the pores in the microcellular and expanded-PTFE layers do not need to be fully compressed. The outer porous layers may have ridges 4 consistent with the technology of the present application.

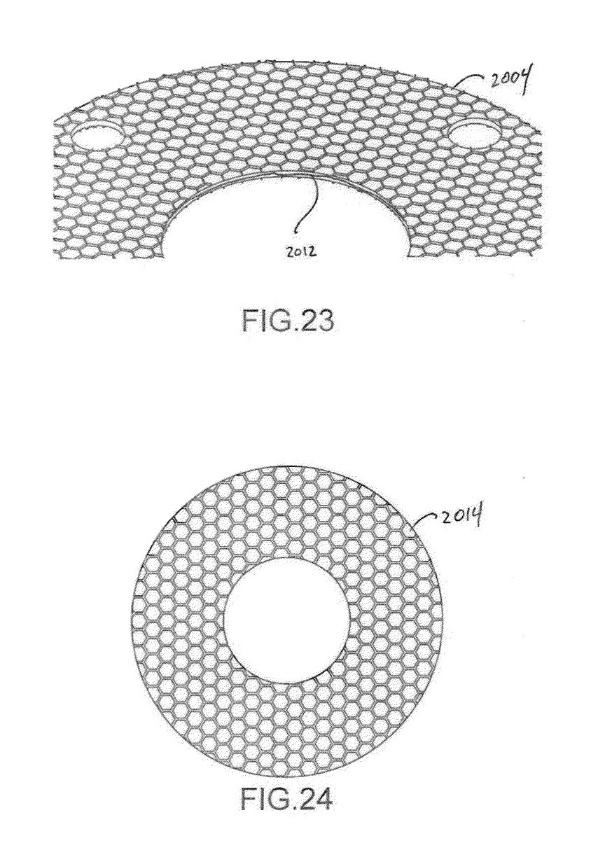

Types of microcellular materials that may be used within the technology of the present application include, for example, GYLON® gasket materials with reference to microcellular style 3540 and 3545. One type of full density sheet material is described in U.S. Pat. No. 4,913,951, which is incorporated herein by reference as if set out in full. Gasket materials described in U.S. Pat. No. 4,913,951 are reinforced with perforated steel sheets for strength. Exemplary gasket materials with steel sheet inserts (as shown in FIG. 23) include GYLON® styles 3560 and 3561 referenced above. It should be noted that the full density sheet material described in U.S. Pat. No. 4,913,951 is a flat sheet of full density PTFE material that is relatively non-compressible that does not form a good seal in low load flange sealing application. In some embodiments, the gasket material 10 may be a PTFE that has undergone processing and that incorporates fillers to provide a material that is compressible and/or less susceptible to creep (i.e., the tendency to slowly move or permanently deform under stress).

The type of filler may include glass microballoons, silica, barium sulfate, graphite, mica, stainless steel, polymeric fillers (PPS, Ekonol, PPSO2, PEEK, etc) and/or other inorganic fillers (silicone carbide, glass fiber, alumina, etc).

The technology of the present application may be implemented using pure full density PTFE, conventional homopolymer or modified PTFE. One example of pure full density PTFE is GYLON® Style 3522 as mentioned above.

The technology of the present application also may be implemented using composite and/or layered structures polymer sheets for the gasket material, such as, for example, a sheet of full density filled and/or unfilled PTFE sheets, such as those described in U.S. Pat. Nos. 4,961,891 and 4,900,629, both of which are incorporated herein by reference as if set out in full. One such a gasket material described is currently commercially available as GYLON® Style 3565, also known as ENVELON®.

All the above GYLON® and other gasket materials can be used in both sintered and/or on sintered form according to the technology of the present patent application.

Furthermore, gasket materials described in this disclosure can be produced from conventional full, density PTFE sheets. Such sheets are manufactured from compression molded granular PTFE powder into a billet and skiving the billet into sheets with various thicknesses. The skived full density PTFE sheets are commercially available from different suppliers in filled and unfilled versions. Inventive gaskets from skived PTFE sheets can be produced with the processes described in this disclosure.

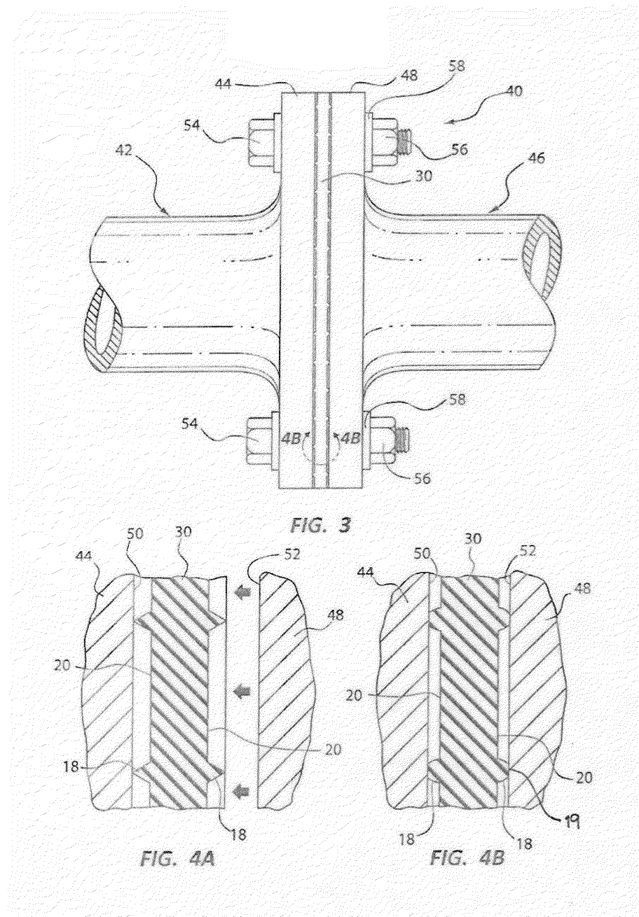

As shown in FIG. 1, the gasket sheet material 10 may have a first major surface 14 and a second major surface 16. The second major surface 16 opposes the first major surface 14. The opposing first and second major surfaces 14 and 16 of the gasket sheet material 10 may provide sealing surfaces for a gasket 30 (see FIG. 2) formed from the sheet of gasket material 19 (e.g., a gasket 39 cut from the sheet of gasket material 10).

The first major surface 14 may comprise interconnected sealing ridges 18 defining an array of indentations 20. The sealing ridges 18, as shown in FIG. 48, form a mating surface 19 with a flange surface. In some embodiments, as shown in FIG. 1, the interconnected sealing ridges 18 may define generally honeycomb (e.g., hexagonal) indentations 20 arranged in a pattern or an array (e.g., a grid). In certain, aspects, the sealing ridges 18 may have different geometries, heights, and angles. For example, the ridges 18 may be triangular, saw tooth, trapezoid, rectangular, elliptical or the like. The interconnection of the ridges define arrays of indentations that, as described more fully below, in certain aspects, may form other geometric shapes or even no discernible pattern.

The gasket material has a density at the sealing ridge 18 regions that is less than the density at the indentation regions 20. Accordingly, the indentation 20 regions of the gasket material may be relatively rigid compared to the sealing ridge 18 regions. Because the sealing ridges 18 have a lower density than the indentations 20, the sealing ridges 18 may be more easily compressed than the indentations 29 and may deform under a relatively low compression, force. In other words, the sealing ridges 18 may have a durometer that is lower than a durometer of the indentations 20.

While shown as a solid, homogeneous material, it may be possible to provide a composite or layered gasket material. In certain aspects, the gasket material 10 may be molded or formed with an insert, such as a metal insert, to provide strength to the sheet material, see for example the metal insert associated with the gaskets of FIG. 23. Additionally, instead of a homogenous material, it may be possible to provide a gasket material 10 with an outer porous layer and a central core of non-porous material, such as, for example, full density PTFE. In certain aspects, such a layered or composite structure may include, for example, a microcellular or expanded PTFE top and bottom layer about a full density PTFE core as shown in FIG. 39. The microcellular or expanded PTFE provides a compressible outer layer to facilitate low bolt loads whereas the full density PTFE core provides enhanced sealing characteristics. The composite may further include a metal insert similar to the metal insert of FIG. 23.

In some embodiments, as shown in FIG. 2, a gasket 30 may be cut from the sheet of gasket material 10. For example, the gasket 30 may be cut from the sheet of gasket material 10 utilizing a steel rule die, a laser, a knife, or another equivalent cutting device.

The gasket 30 may be sized and configured for a specific flange joint. In view of the repeated pattern of sealing ridges 18 and indentations 20 in the sheet of gasket material 10, a plurality of sizes and shapes of gaskets may be cut from, a sheet of gasket, material 10. As can be seen, contrary to alternative gaskets, the sealing ridges 18, which form the sealing surfaces, are generally oriented at random angles to a fluid conduit 32 (or central aperture 32) of the gasket material. Also, the sealing ridges 18 and indentations 20 form an area 21 having that is significantly less than the area 31 defined by the central aperture 32. This allows for a plurality of sealing ridges 18 between the fluid medium and the outer surface 33 of the cut gasket 30. The width of gasket 30, defined by the difference between an outer radius R₂ and an inner radius R₁. generally should be greater than the maximum dimension of the indentations 20. The plurality of sealing ridges 18 provide for improved resistance to leak paths.

In the embodiment shown in FIG. 2, the gasket 30 includes a central aperture 32, fastener apertures 34, and an alignment tab 36. The central aperture 32 may be sized and configured to correspond to an opening in opposing pipe flanges. Notably, the sealing ridges 18 are not configured to correspond radially to the central aperture 32, but rather cut across the gasket, which allows the sheet of gasket material 10 to allow for a variety of piping sizes and dimensions. Additionally, the fastener apertures 34 may be positioned and sized to correspond to openings in a flange joint in which bolts or other fasteners may be inserted. The alignment tab 36 may be sized to extend beyond the outer diameter of a flange joint when installed.

FIG. 3 shows the gasket 30 installed at a joint 40 at a view where the alignment tab 36 is not observable. As shown, a first pipe 42 may comprise a first flange 44, A second pipe 46 may comprise a second flange 48, opposing the first flange 44 of the first pipe 42. Each of the first and second flanges 44 and 48 may comprise apertures for the insertion of fastener. For example, each of the first and second flanges 44 and 48 may comprise four circumferentially spaced apertures for fasteners.

To form the joint 40, a face 50 of the first flange 44 of the first pipe 42 may be positioned proximate to a face 52 of the second flange 48 of the second pipe 46. The apertures of the first flange 44 may be substantially aligned with the apertures of the second flange 48. The first and second flanges 44 and 48 may be sufficiently spaced apart to facilitate the insertion of the gasket 30 between the faces 50 and 52, and the gasket may be installed between, the first flange 44 and the second flange 48, as shown in FIG. 4A.

When the gasket 30 is positioned between the faces 50 and 52 of the first and second flanges 44 and 48, the alignment tab may be used to rotate the gasket 30 to align the fastener apertures 34 of the gasket 30 with the fastener apertures of the first and second flanges 44 and 48. Bolts 54 may then be inserted into the aligned apertures of the first and second flanges 44 and 48 and the fastener apertures 34 of the gasket 30. Nuts 56 and washers 58 may be installed on each bolt 54.

As shown in FIG. 4A, prior to tightening the fasteners (e.g., tightening the nuts 56 onto the bolts 54) the gasket 30 may be in an uncompressed state. In the uncompressed state, the sealing ridges 18 of the gasket 30 may exhibit a generally V-shaped cross-section; the side surfaces of the sealing ridges 18 meeting at a relatively sharp peak. Alternative geometries are possible as explained above.

As the fasteners are tightened, the peaks of the sealing ridges 18 of the gasket 30 are compressed by the faces 50 and 52 of the first and second flanges 44 and 48. As the fasteners are further tightened, the sealing ridges 18 may deform and seal against the faces 50 and 52 of the first and second flanges 44 and 48 under a relatively low bolt load to form sealing surfaces 19. as shown in FIG. 4B. Due to the relatively low density and the geometric shape of the sealing ridges 18, the gasket 30 effectively seals the joint 40 under a relatively low bolt load, when compared to a bolt load required to seal a similar joint using a gasket with substantially planar sealing surfaces. As can be appreciated, the ridges 18 deform by compressing towards the indented surface 20 and bulge outwardly. The deformation of ridges 18 forms a sealing surface 19, which is a surface to surface contact with the flange face.

The pressure applied to the gasket 30 by the faces 50 and 52 of the first and second flanges 44 and 48 may be calculated by the equation: P=F/A. Wherein P is the pressure applied to each major surface 14, 16 (e.g., each sealing surface) of the gasket 30, F is the force applied to the gasket 30 by the faces 50 and 52 of the first and second flanges 44 and 48 via the bolts (i.e., the bolt load), and A is the area of the respective major surface 14, 16 of the gasket 30 in contact with a respective flange face 50, 52. Accordingly, as the surface area A is decreased under a specific force F, the pressure P will correspondingly increase.

The geometry of the sealing ridges 18 of the gasket 30 may provide a significantly reduced, surface area in contact with the faces 50 and 52 of the first and second flanges 44 and 48, compared to a planar geometry. Thus, the geometry of the sealing ridges 18 may facilitate a significant pressure on the gasket 30 under a relatively low bolt load.

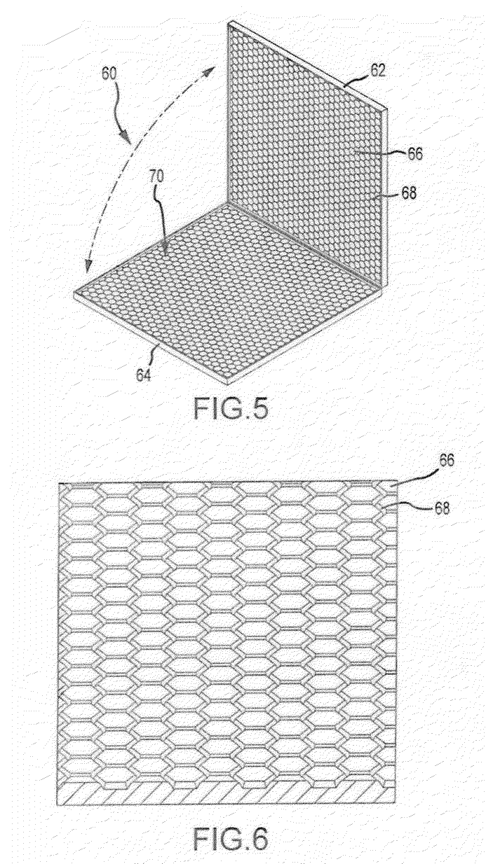

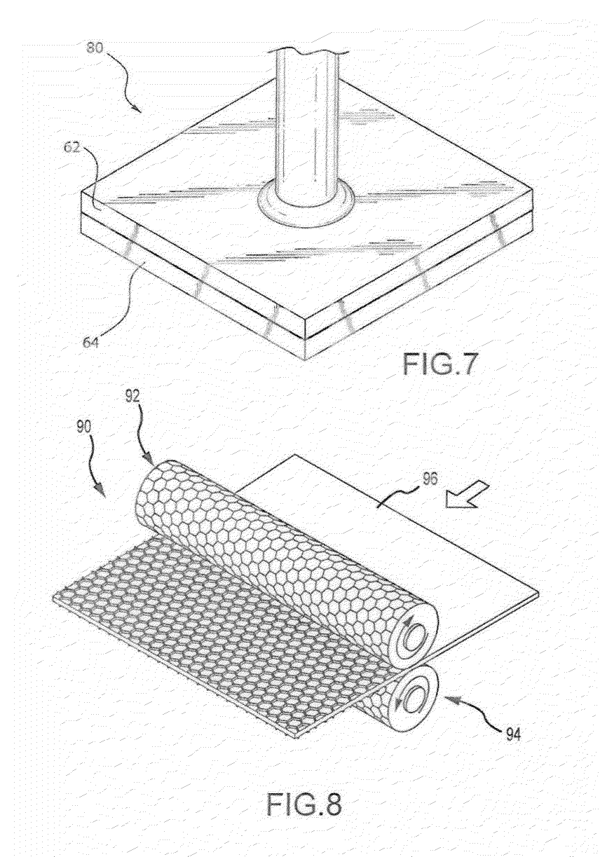

A mold 60 for manufacturing a sheet of gasket material, such as the sheet of gasket material 10 shown in FIG. 1, is shown in FIG. 5. As shown, the mold 60 may comprise an upper plate 62 and a lower plate 64. Each of the upper plate 62 and the lower plate 64 may comprise an array of protrusions 66 and surrounding interconnected valleys 68.

As may be observed in the detail view of FIG. 6, the protrusions 66 may each be shaped generally as a base of a hexagonal pyramid, with a hexagonal shaped upper surface surrounded by six tapered side surfaces. Meanwhile, each of the valleys 68 may be generally V-shaped, extending in a grid-like arrangement.

When the upper plate 62 is positioned over on the lower plate 64, a cavity 70 may be defined between the upper plate 62 and the lower plate 64 corresponding to the shape of the sheet of gasket material 10. Accordingly, the array of protrusions 66 in the upper and lower plates 62 and 64 may correspond to the array of indentations 20 in the first and second major surfaces 14 and 16, respectively, of the sheet of gasket material 10. Likewise, the valleys 68 may correspond to the sealing ridges 18 of the first and second major surfaces 14 and 16, respectively, of the sheet of gasket material 10. As explained for the above, the mold may allow for variances in the geometry of the sealing ridges.

To form the sheet of gasket material 10 (see FIG. 1), a polymer sheet having substantially planar major surfaces may first be formed. In some embodiments, a sheet of PTFE of proper thickness may be formed using known processing techniques. For certain unsintered full density sheets of PTFE may require the use of a solvent. In these cases, the sheet of PTFE may be dried for six hours at about 225° F. (about 10° C.) to remove any solvent that may be remaining in the formed sheet.

The sheet of PTFE may then be heated to a gel point (e.g., about 700° F. (about 371° C.) for about fifteen minutes in a ventilated batch oven. Thereafter, the heated sheet of PTFE may be transferred from the batch oven to the mold 60 (see FIG. 5) that may be at room temperature. The transfer should be rapid to prevent significant cooling prior to placement in the mold. The mold 60 may be closed and the sheet of PTFE may then be cooled under a pressure between about 2000 pounds per square inch (psi) (about 13.8 megapascals (MPa)) and about 3000 psi (about 20.7 MPa) in a hydraulic press 80 for approximately one minute. The mold 60 may then be opened and the gasket material 10 having the desired shape removed therefrom.

The foregoing process, known as hot coining, together with the geometry of the mold 60 creates regions of differing compressibility, density, hardness and/or durometer rating within the sheet of gasket material 10. While hot coining the gasket material 10 is satisfactory, the gasket material 10 may be formed by cold coining as well, as will, be explained with reference to FIGS. 34-39. The areas of the sheet of gasket material 10 wherein the indentations 20 are formed are compressed to a greater extent than the areas wherein the sealing ridges 18 are formed during the coining process, resulting in higher densification of the filled PTFE in the areas of the indentations 20. These regions may impart strength and rigidity to the portions of sheet of gasket material 10, and thus gaskets 30 formed therefrom. In the regions of the sealing ridges 18, a reduced level of densification results, yielding regions of relatively high compressibility,

In some embodiments, suitable fillers, such as one or more of barium sulphate, silica, graphite, and microballoons, can be utilized to provide desired mechanical properties and/or chemical resistance of the PTFE for various applications. Further embodiments may include metal and/or other material that is incorporated into the sheet of gasket material 10, and thus the gasket 30.

In further embodiments, a heated polymer sheet 96 having substantially planar major surfaces may be fed into and pressed by a roller press 90, as shown in FIG. 8, to form the sheet of gasket material 10. The roller press 90 may comprise opposing drum-shaped rollers 92 and 94. An upper roller 92 may be positioned adjacent to a lower roller 94, the space between the rollers 92 and 94 selected according to the desired final dimensions of the sheet of gasket material 10. Each of the upper roller and the lower roller may comprise an array of protrusions and surrounding valleys positioned and configured to impart corresponding indentations 20 and sealing ridges 38 in the heated polymer sheet 96 to form the sheet of gasket material 10. In order to cool the heated polymer sheet 96 within the roller press 90, the rollers 92 and 94 may be cooled to a temperature below an ambient temperature (e.g., below about 70° F. (below about 21° C.).

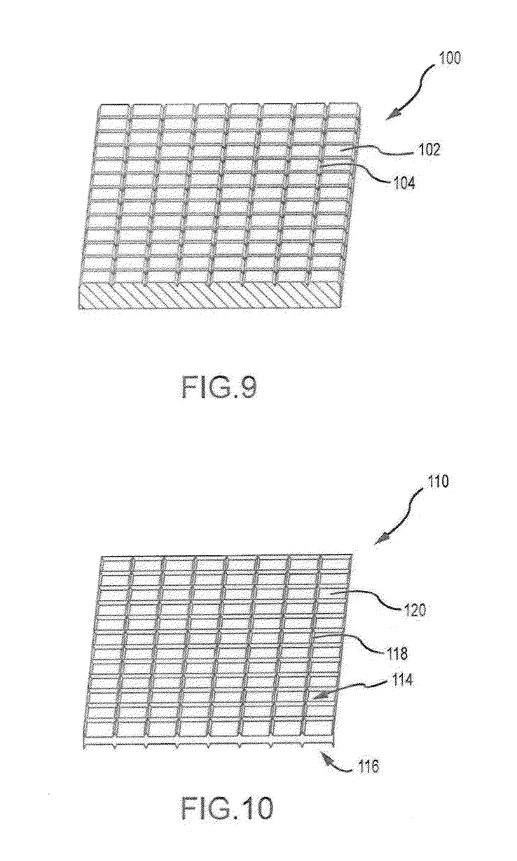

As shown in FIG. 9, in some embodiments, a mold 100 may be used that may impart a polygonal geometry other than a hexagonal geometry, such as square or rectangular cells (e.g., a grid geometry). The mold 100 may comprise an array of square or rectangular protrusions 102 surrounded by interconnected valleys 104. Each protrusion 102 may comprise a surface surrounded by six tapered side surfaces, and each of the interconnected valleys 104 may be generally V-shaped, which forms a beveled or tapered sheet (as shown below). Alternatively, the protrusions may be a surface surrounded by vertical side surfaces that do not taper.

As shown in FIG. 10, a sheet of gasket material 110 manufactured using the mold described with reference to FIG. 9 may comprise a first major surface 114 and a second major surface 116 each comprising a plurality of square indentations 120 surrounded by interconnected sealing ridges 118. Sheets of gasket material comprising polygonal geometric patterns of polygonal shapes, in addition to squares and hexagons, may be manufactured and utilized to provide gaskets according to additional embodiments of the present disclosure.

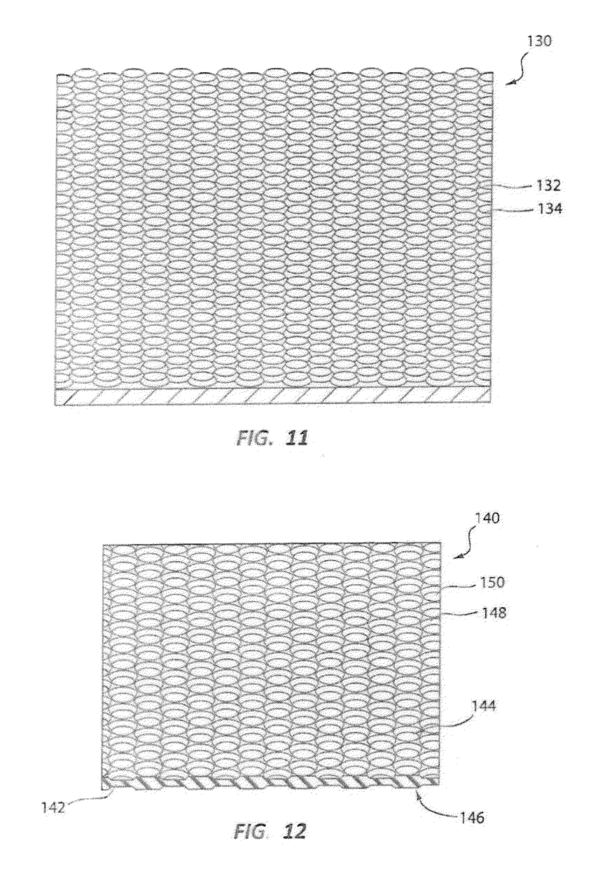

In additional embodiments, non-polygonal shaped protrusions also may be utilized in a mold. For example, as shown in FIG. 11, in some embodiments, a mold 130 may be utilized that may impart an array of generally circular indentations. The mold 130 may comprise an array of circular protrusions 132 surrounded by interconnected valleys 134. Each circular protrusion 132 may comprise a circular surface surrounded by a tapered side surface. For example, each circular protrusion 132 may be shaped as a truncated cone (i.e., a frustrum). The interconnected valleys 134 may include a generally flat surface, substantially parallel to the circular surfaces of the circular protrusions 132, and a plurality of sloped side surfaces. Alternatively, instead of a truncated cone, the protrusions 132 may be cylindrical.

As shown in FIG. 12, a sheet of gasket material 140 manufactured using the mold described with reference to FIG. 11 may comprise a first major surface 144 and a second major surface 146 each comprising a plurality of frustoconical indentations 150 surrounded by interconnected sealing ridges 148. As shown, the interconnected, sealing ridges 148 may have a substantially planar upper surface, rather than, or in addition to, an extending sharp peak (see FIGS. 1, 2, 4 and 10). Sheets of gasket material comprising polygonal geometric patterns of shapes in addition to polygons, circles, and conical sections may be manufactured and utilized to provide gaskets according to additional embodiments of the present disclosure.

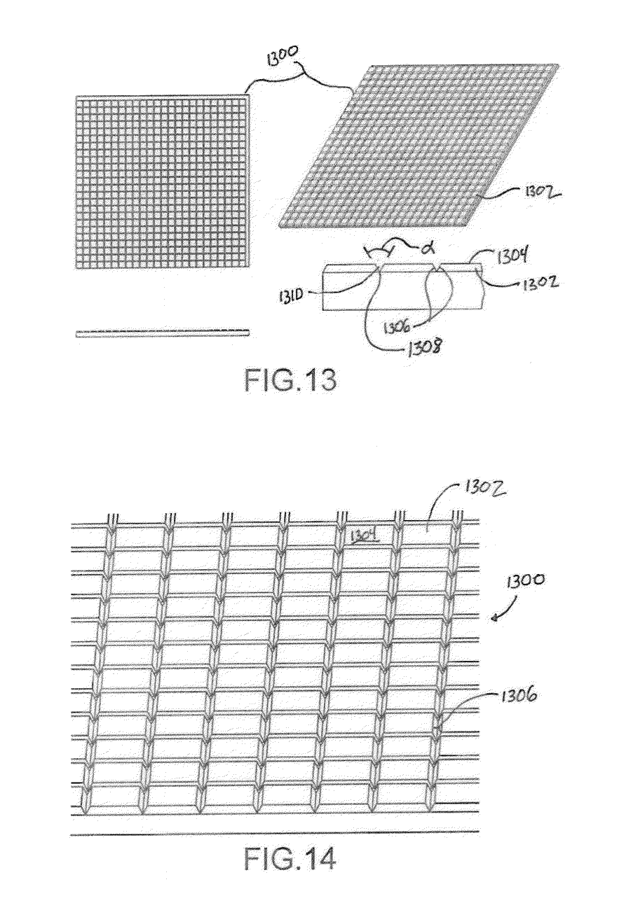

One half of a mold 1300 is shown in FIG. 13 and an isometric view of part of the mold 1300 is shown in FIG. 14. The mold 1300 is a square mold having protrusions 1302 with a flat surface 1304 and tapered sidewalls 1306 terminating at an edge 1308. FIG. 18 shows a sheet 1800 formed using the square mold. As shown the tapered sidewalls 1306 form an angle α, which is 60° degrees in this exemplary embodiment, but could be anywhere from about 45° to 90° degrees. At 90° degrees, angled side walls would terminate in a floor 1308 that would be surface rather than an edge as presently shown. Terminating the sidewalls 1308 at a line or edge contact, forming a triangular cross-section 1310 reduces the bolt load required to form a sealing surface on the final gasket. When the angle is less than 90° degrees, the protrusions form a trapezoidal cross-section 1312. If the angle is 90° degrees, the protrusion forms a rectangular cross-section. While shown symmetrical, protrusion 1302 and tapered sidewalls 1306 may be asymmetrical in certain aspects of the technology.

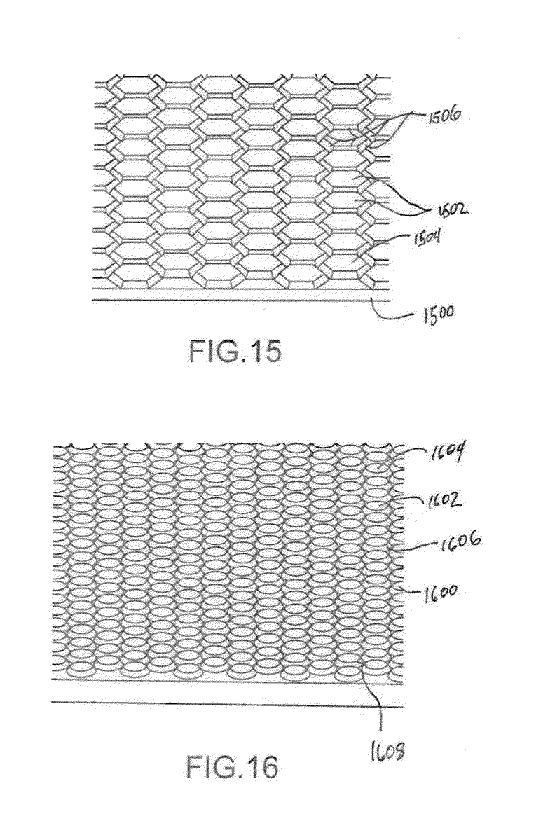

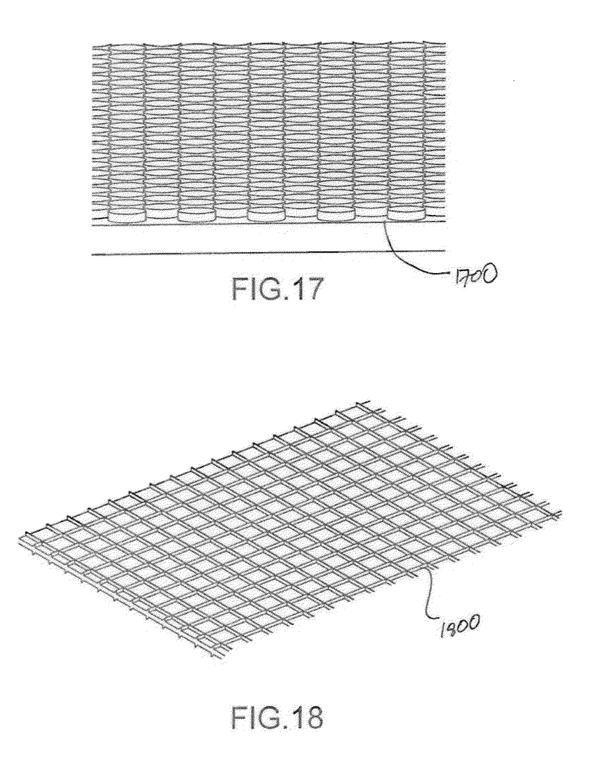

FIG. 15 shows a part of one half of a mold 1500 for a gasket having beveled hexagonal ridges. The mold 1500 is provided with protrusions 1502 having a flat surface 1504 and six tapered sidewalls 1506. FIG. 16 shows one half of a mold 1600 for a gasket having beveled Circular ridges. The mold 1600 is provided with protrusions 1602 having a flat surface 1604 and a tapered side wall 1606 forming a frustoconical shape. If the sidewall 1606 was not tapered, it would be cylindrically shaped. Unlike other molds, the frustoconical shape mold produces a gasket that has ridges of varying thickness as the separation 1608 between the various protrusions varies. FIG. 17 shows one half of a mold 1700 with cylindrical sidewalls.

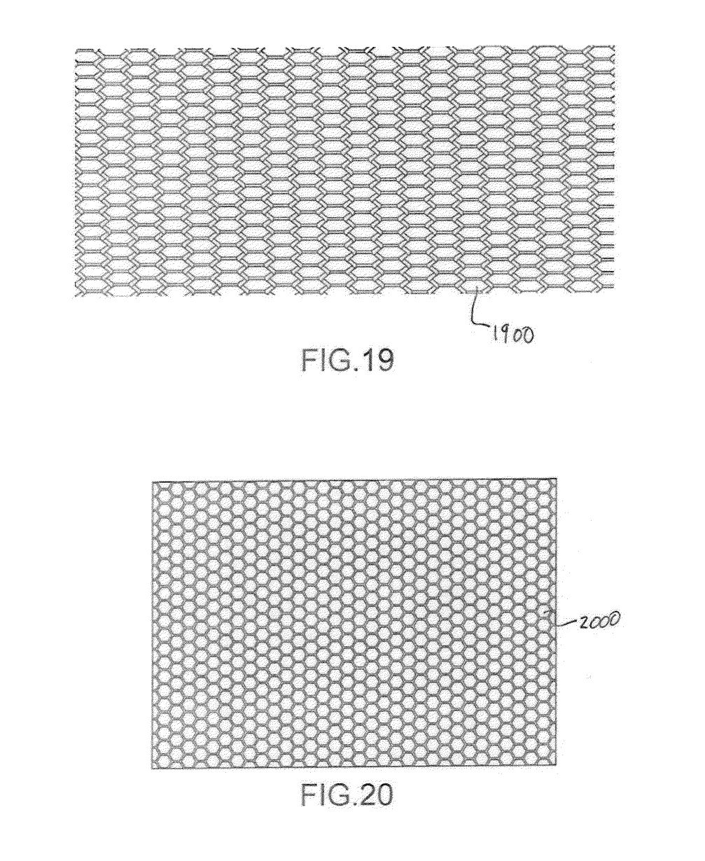

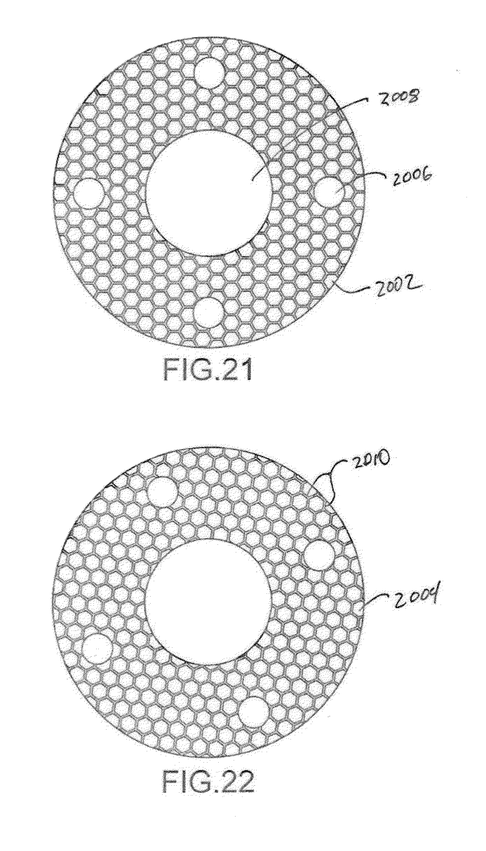

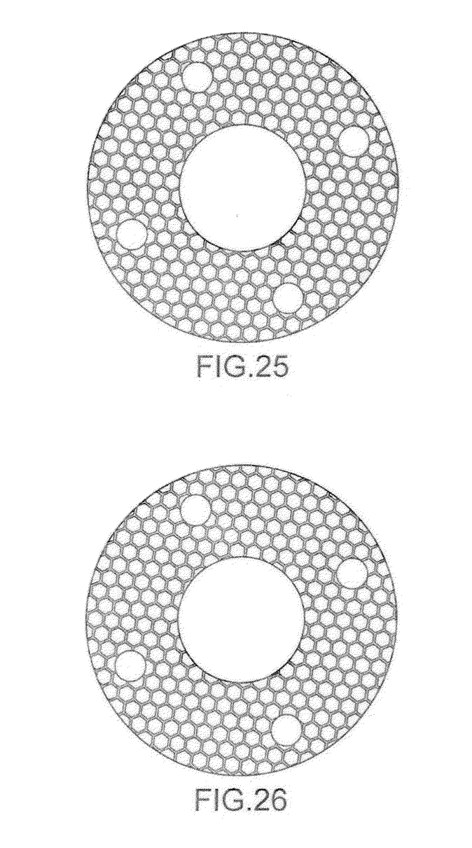

FIG. 19 shows a portion of a mold 1900 for forming a honeycomb or hexagonal, sheet 2000 of gasket material, shown in FIG. 20. The hexagonal sheet 2000 can be cut into a plurality of gaskets 2002, 2004, which are shown in FIGS. 21 and 22. The plurality of gaskets 2002, 2004 have a plurality of fastener apertures 2006 and a fluid aperture 2008, generally shown at the geometric center of the gaskets 2002, 2004. A plurality of ridges 2010, forming the hexagonal pattern, forms a plurality of seals when arranged between connecting flanges. FIG. 23 shows the gasket 2004 where a metal insert 2012 is molded into the gasket 2004. The insert 2012 provides structural integrity to the gasket 2004 and facilitates creep resistance. FIG. 24 provides a ring gasket 2014, which is similar to gaskets 2002 and 2004 without the plurality of fastener apertures. Ring gasket 2014 may be provided with the metal insert 2012. FIGS. 25, 26, 27A, 27B, and 28 provide still more gaskets of difference sizes and materials, which may result in different coloring of the gaskets, but similar functionality.

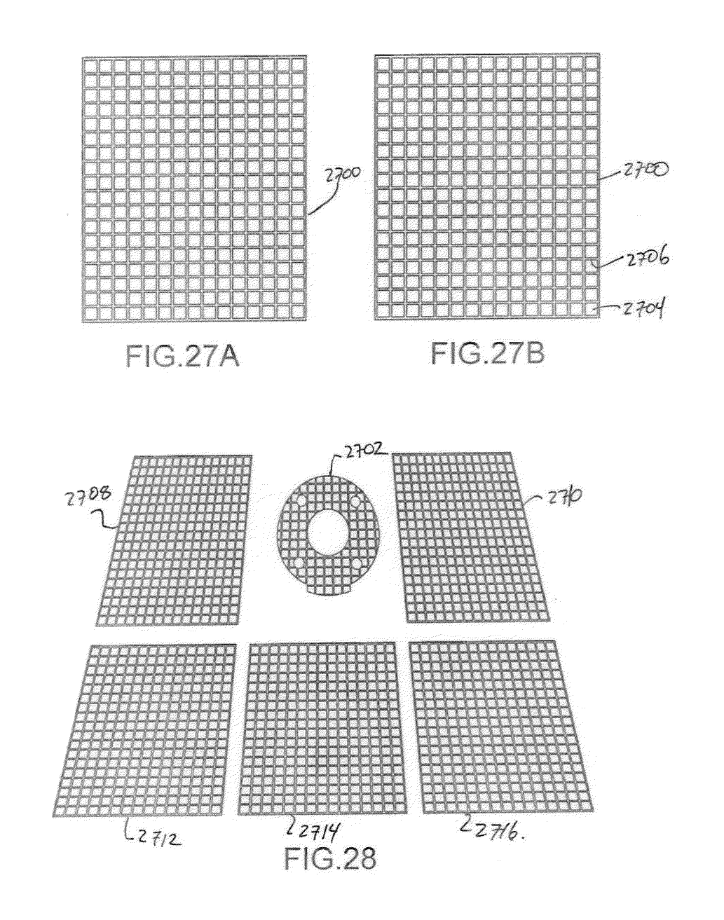

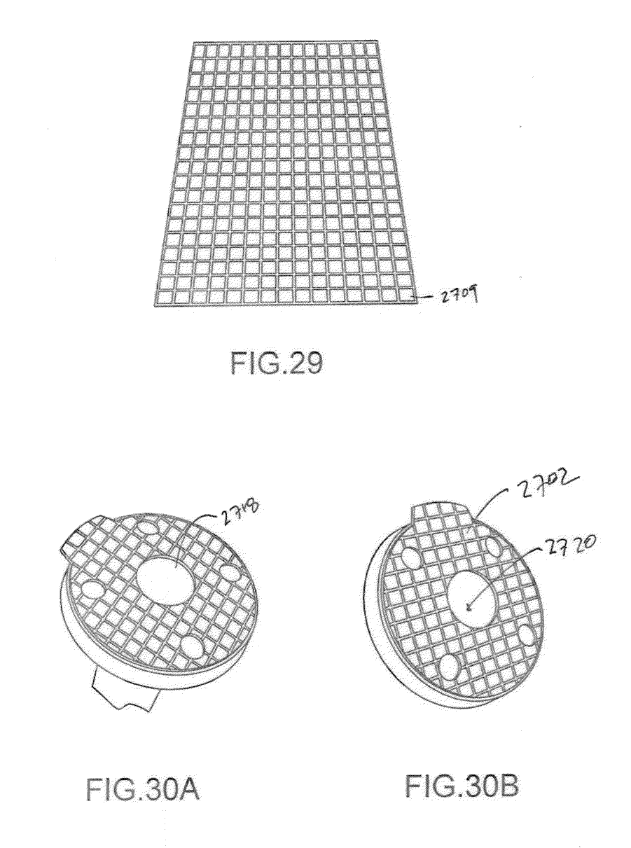

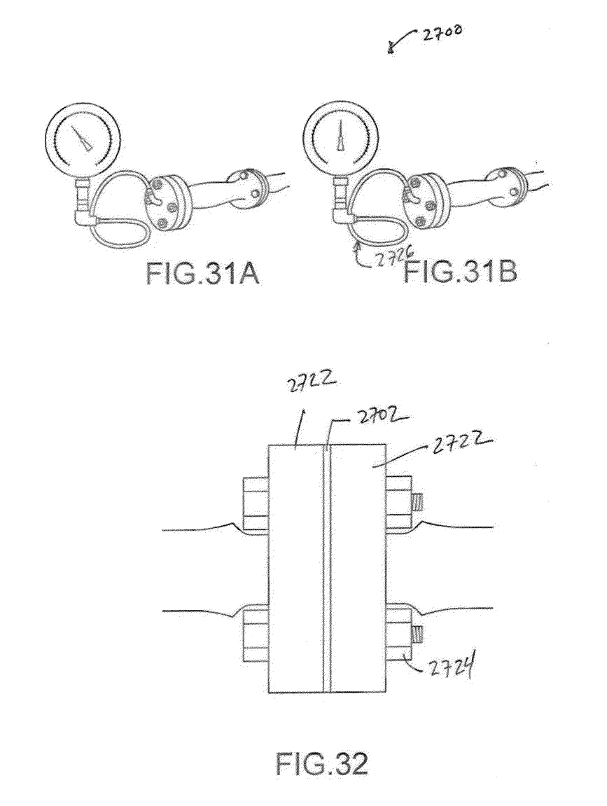

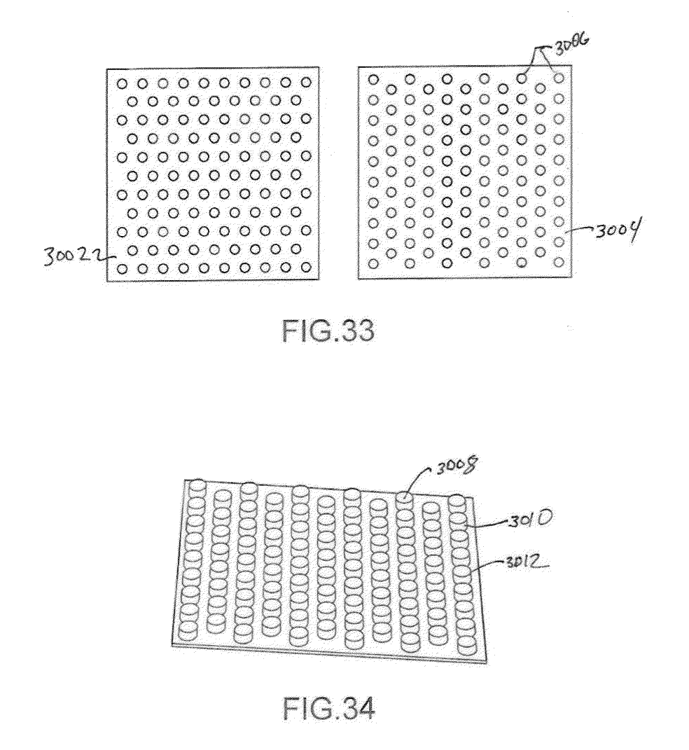

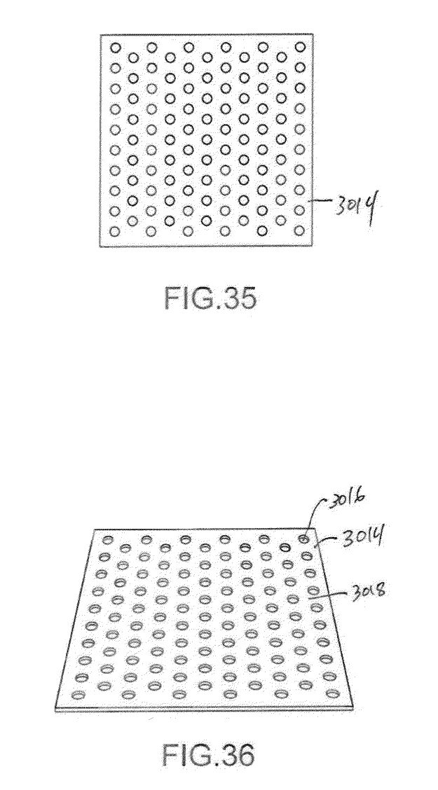

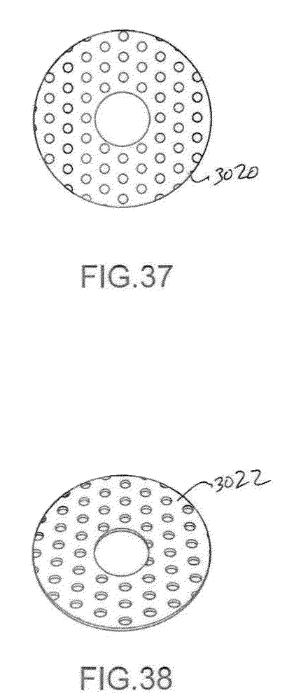

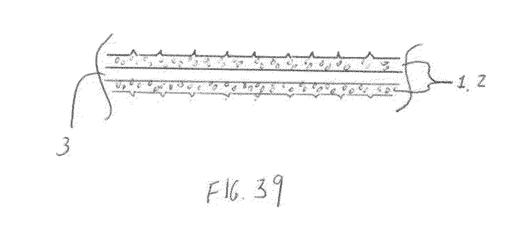

With reference to FIGS. 31A, 31B and 32, a test rig 2700 for a sample gasket 2702 is provided. With reference first to FIGS. 27A, 27B, 28, 29, 30A, and 30B, a gasket 2702 is formed using mold 2700, which in this case is a square pattern mold having square protrusions 2704 surrounded by side walls 2706. Using the mold, gasket sheet material may be formed using a variety of materials including restructured PTFE gasket sheet material 2708, 2710, or metal inserted restructured PTFE gasket sheet material 2712, 2714, 2716, The gasket sheet material may be cut to form a gasket 2702, which is similar to gasket 100 described above. In the example, the gasket 2702 is formed using restructured PTFE without a metal insert. FIG. 29 shows restructured PTFE gasket sheet material 2709 in more detail. FIGS. 30-31 show aligning the gasket 2702 such that the fluid aperture 2718 aligns with the fluid aperture 2720 of a pipe in the test rig 2700. As shown in FIG. 33, the gasket 2702 is oriented between two connecting flanges 2722 and a low torque bolt load is provided by connecting bolts/nuts 2724. One end of the test rig 2700, which may be deadheaded, is connected to a pressure source 2726. The test rig 2700 may be a fluid loop or have an inlet and outlet to simulate flow conditions as desired.

As can be appreciated, the above gaskets and gasket sheet material were formed using a hot method in which the gasket sheet material is heated to a gel or activation state, semi-fluid, and molded. However, it has been recently discovered that it is possible to cold form the gasket sheet material described herein. Now, with reference to FIGS. 33-38, an exemplary method for forming a gasket sheet material is described using a cold coining method.

While any of the gasketing material previous described may be used in the cold coining method, one gasketing material that has been found to be satisfactory includes filled or unfilled PTFE sheet made from granular PTFE powders. In general, the granular PTFE sheets are produced by preparing a perform, sintering th perform, and then fabricating the parts, in this case the final sheets. The granular PTFE is placed in a mold under a pressure of 3,000 to 5,000 psi with dwell times varying with the preform size. The preform is next sintered in a programmable over. The temperature of the preform is slowly raised from room temperature to between 350° to 390° C. and the temperature is held for a period of time, depending on the part geometry, dimensions, and the like, allowing the void to be filled. The over is then slowly lowered back to ambient temperature. The full density or restructure PTFE sheet is next skived from the carrier. The flat gasket sheet is placed between a pair of molding sheets, such as molds 3002 and 3004 at essentially ambient temperature. Molding sheets 3002, 3004 have protrusions 3006 with flat surfaces 3008 that transition to a cylindrical sidewall 3010 over a beveled edge 3012. The gasket sheet is then stamped, pressed, by the under sufficient force of approximately 2500 psi to 5000 psi to plastically deform the gasket sheet until if forms a dimpled gasket sheet 3014. Dimpled gasket sheet 3014 has a series of indented regions 3016 of a first density surrounded by a ring 3018 having a second density less than the first density. The first density being higher (because the gasket is more compressed) provides strength and rigidity to the gasket and or dimpled gasket sheet 3014 whereas the ring 3018 provides increased compressibility similar to the above gaskets. The sheets may be cut into gaskets, such as, ring gaskets 3020, 3022.

It should be recognized that the various embodiments described herein are merely illustrative, and not limiting to the scope of the invention. Numerous modifications and adaptations of the embodiments described will be readily apparent to those skilled in the art without, departing from the scope of the present invention.

What is claimed is:

1. A method of manufacturing a non-porous sheet of gasket material having a plurality of densities therein, the method comprising:
inserting a polymer sheet into a press; and
pressing the polymer sheet, with a mold comprising opposing arrays of protrusions to define interconnected sealing ridges surrounding an array of indentations on each major surface of the polymer sheet, wherein the pressed polymer sheet is non-porous.

2. The method of claim 1, further comprising heating the polymer sheet prior to pressing the polymer sheet.

3. The method of claim 2, wherein heating the polymer sheet prior to pressing the polymer sheet comprises heating the polymer sheet to a gel point to substantially remove any porosity.

4. The method of claim 2, wherein heating the polymer sheet prior to pressing the polymer sheet comprises heating the polymer sheet to a temperature of about 371° C.

5. The method of claim 4, further comprising heating the polymer sheet, within the mold.

6. The method of claim 5, further comprising heating the polymer sheet for about 15 minutes.

7. The method of claim 2, further comprising cooling the polymer sheet within the mold.

8. The method of claim 7, wherein cooling the polymer sheet within the mold comprises cooling the polymer sheet within the mold for about ten minutes.

9. The method of claim 1, wherein pressing the polymer sheet with the mold further comprises forming indented regions having a first density and interconnected sealing ridges having a second density less than the first density.

10. The method of claim 2, wherein inserting the polymer sheet into the press farther comprises inserting a polytetraflouroethylene (PTFE) sheet into the press heating the PTFE sheet sufficiently heats the PTFE sheet to make the PTFE sheet non-porous.

11. The method of claim 10, wherein inserting the PTFE sheet into the press further comprises inserting a PTFE sheet filled with at least one of microballoons, barium sulphate, and crystalline silica into the press.

12. The method of claim 30, further comprising drying the PTFE sheet to substantially remove any solvent within, the PTFE sheet prior to inserting the PTFE sheet into the press.

13. The method of claim 12, further comprising drying the PTFE sheet to substantially remove any solvent within the PTFE sheet prior to inserting the PTFE sheet into the press.

14. The method of claim 13, wherein drying the PTFE sheet comprises heating the PTFE sheet to a temperature of about 107° C.

15. The method of claim 1, further comprising applying an average pressure of between about 13.8 MPa and about 20.7 MPa to the polymer sheet with the press.

16. A gasket material, comprising:
a non-porous polymer sheet comprising a first major surface and a second major surface, the second major surface opposing the first major surface:
interconnected sealing ridges defining an array of indentations on the first major surface of the non-porous polymer sheet, the interconnected sealing ridges having a first density and the indentations having a second density greater than the first density;
interconnected sealing ridges defining an array of indentations on the second major surface of the non-porous polymer sheet, substantially symmetric to the first major surface.

17. The gasket material of claim 16, wherein the polymer sheet comprises a full density polytetraflouroethylene (PTFE) sheet.

18. The gasket material of claim 17, wherein the PTFE sheet comprises full density PTFE filled with at least one of microballoons, barium sulphate, and crystalline silica.

19. The gasket material of claim 17, wherein the interconnected sealing ridges form a plurality of geometries.

20. The gasket material of claim 17, wherein the interconnected sealing ridges in the first major surface define an array of rectangular indentations on the first major surface of the full density PTFE sheet and the interconnected sealing ridges in the second major surface define an array of rectangular indentations on the second major surface of the full density PTFE sheet.
